(19) United States
(12) Patent Application Publication
(10) Pub. No.: US 2017/0353095 A1
(43) Pub. Date: Dec. 7, 2017

(54) Driving Device And Bladeless Fan Utilizing the Same

(71) Applicant: Johnson Electric S.A., Murten (CH)

(72) Inventors: Ronny KEIL, Shenzhen (CN); Jie CHAI, Shenzhen (CN); Jing CHEN, Shenzhen (CN); Tao ZHANG, Shenzhen (CN); Yue LI, Hong Kong (CN)

(21) Appl. No.: 15/601,608

(22) Filed: May 22, 2017

(30) Foreign Application Priority Data
Jun. 3, 2016 (CN) 2016 1039 4996.8

(51) Int. Cl. H02K 49/10; F04B 35/04; F04F 5/20; H02K 1/27

(52) U.S. Cl. CPC H02K 49/102; H02K 1/2786; F04B 35/04; F04F 5/20

(57) ABSTRACT

A driving device configured to drive a rotary body includes a motor assembly and a plurality of first magnets disposed on the rotary body along a circumferential direction thereof. Sides of the magnets facing the motor assembly form a plurality of magnetic poles. Upon rotation of the motor assembly, the magnets is driven by magnetic interaction between the motor assembly and the magnetic member to rotate to drive the rotary body to rotate. The present invention also provides a bladeless fan including this driving device.

### CROSS REFERENCE TO RELATED APPLICATIONS

This non-provisional patent application claims priority under 35 U.S.C. §119(a) from Patent Application No. 201610394996.8 filed in The People's Republic of China on Jun. 3, 2016.

### FIELD OF THE INVENTION

The present invention relates to the field of motor driving, and in particular to an improved driving device and a bladeless fan utilizing the driving device.

### BACKGROUND OF THE INVENTION

Currently, motor driving has becoming an indispensable driving manner in people's daily lives. Traditionally, relevant parts driven by motors to move are manly driven through integrated gearboxes in a mechanical manner. This driving manner causes issues such as mechanical friction, wear and noise. This driving manner cannot meet needs required by low-noise apparatuses such as bladeless fans. In addition, a large number of components are used in the traditional design, which makes fabrication of the driving device more complicated.

### SUMMARY OF THE INVENTION

Thus, there is a desire for an improved driving device and a bladeless fan utilizing the driving device.

A driving device configured to drive a rotary body includes a motor assembly. The driving device further includes a magnetic member disposed on the rotary body along a circumferential direction thereof. A side of the magnetic member facing the motor assembly forms a plurality of magnetic poles. Upon rotation of the motor assembly, the magnetic member is driven by magnetic interaction between the motor assembly and the magnetic member to thereby drive the rotary body to rotate.

Preferably, the magnetic member is a magnetic ring magnetized to have multiple N-polarities and S-polarities arranged alternatively along a circumferential direction of the magnetic ring.

Preferably, the magnetic member includes a plurality of first magnets arranged along the circumferential direction of the rotary body, and surfaces of the first magnets away from the rotary body have N-polarities and S-polarities alternatively arranged along a circumferential direction of an annular wall of the rotary body.

Preferably, the rotary body comprises an annular wall, the magnetic member is mounted on the annular wall, and a side of the magnetic member away from the annular wall has N-polarities and S-polarities alternatively arranged along a circumferential direction of an annular wall.

Preferably, the motor assembly includes a motor and a second magnet connected to the motor, the second magnet includes a first semi-cylinder and a second semi-cylinder, a circumferential surface of the first semi-cylinder and a circumferential surface of the second semi-cylinder have opposite polarities, the second magnet is accommodated in the rotary body and is offset from a center of the rotary body, the magnetic member is disposed between the rotary body and the second magnet, and an axis of the second magnet is parallel to an axis of the annular wall.

Preferably, the motor is a single-phase brushless direct current motor, a multi-phase brushless direct current motor, a step motor or a synchronous motor.

Preferably, the motor assembly is a permanent magnet motor which includes a stator and a rotor having a plurality of permanent magnets, and the rotary body rotates under magnetic interaction between the plurality of permanent magnets and the magnetic member.

Preferably, the permanent magnet motor is an outer-rotor unidirectional permanent magnet motor.

A bladeless fan includes the driving device described above. The bladeless fan includes a base, a pressurizer, and a nozzle. One end of the rotary body is rotatably connected to the base. The motor assembly is mounted to the base. The nozzle is connected to one end of the rotary body away from the base. The driving device is configured to drive the rotary body to rotate relative to the base, and the pressurizer is configured to suck and pressurize air such that the pressurized air is ejected out via the nozzle.

Preferably, the base has an accommodating space, and the pressurizer is mounted in the accommodating space.

Preferably, a tray protrudes from the base in an interior thereof, and the motor assembly is mounted on the tray.

Preferably, the rotary body has an accommodating chamber, and the pressurizer is mounted in the accommodating chamber.

Preferably, the motor assembly is mounted at a bottom of the base.

Preferably, a circumferential wall of the base defines a plurality of air inlets.

Preferably, the bladeless fan further includes a conducting wire disposed at the base.

In the driving device of embodiments of the present invention, the rotary body rotates under the magnetic interaction between the motor assembly and the magnetic member. This contactless magnetic driving manner results in lowered noise. In addition, the bladeless fan of embodiments of the present invention realizes contactless magnetic driving by using this driving device and, therefore, the noise is lowered as the rotary body rotates relative to the base. Furthermore, using this driving device reduces cost and facilitates the fabrication thereof.

### BRIEF DESCRIPTION OF THE DRAWINGS

FIG. 1 illustrates a bladeless fan in accordance with a first embodiment of the present invention.

FIG. 2 illustrates a driving device and a rotary body shown in FIG. 1.

FIG. 3 illustrates the driving device and the rotary body shown in FIG. 1, viewed from another aspect.

FIG. 4 illustrates the driving device and rotary body in accordance with another embodiment of the present invention.

FIG. 5 illustrates a bladeless fan in accordance with a second embodiment of the present invention.

### DETAILED DESCRIPTION OF THE PREFERRED EMBODIMENTS

The technical solutions of the embodiments of the present invention will be clearly and completely described as follows with reference to the accompanying drawings. Apparently, the embodiments as described below are merely part of, rather than all, embodiments of the present invention. Based on the embodiments of the present invention, any other embodiment obtained by a person skilled in the art without paying any creative effort shall fall within the protection scope of the present invention.

It is noted that, when a component is described to be “fixed” to another component, it can be directly fixed to the another component or there may be an intermediate component. When a component is described to be “connected” to another component, it can be directly connected to the another component or there may be an intermediate component. When a component is described to be “disposed” on another component, it can be directly disposed on the another component or there may be an intermediate component.

Unless otherwise specified, all technical and scientific terms have the ordinary meaning as commonly understood by people skilled in the art. The terms used in this disclosure are illustrative rather than limiting. The term “and/or” used in this disclosure means that each and every combination of one or more associated items listed are included.

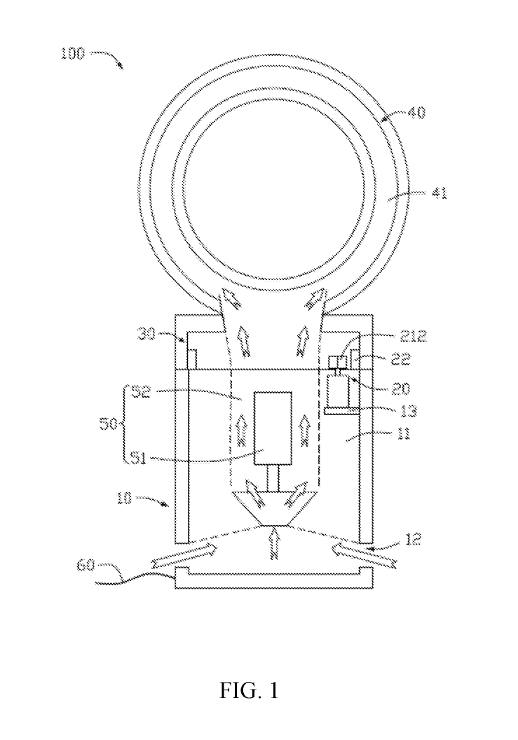

FIG. 1 illustrates a bladeless fan 100 in accordance with one embodiment of the present invention. The bladeless fan 100 is configured to suck air, pressurize the sucked air, and eject the pressurized air to generate an airflow desired by a user. The bladeless fan 100 includes a base 10, a driving device 20, a rotary body 30, a nozzle 40, and a pressurizer 50. One end of the rotary body 30 is connected to the nozzle 40. At a connection area between the rotary body 30 and the nozzle 40, a flow conduit is mounted, which is in communication with the nozzle 40 and the pressurizer 50. The driving device 20 is configured to drive the rotary body 30 to rotate any angle in the range of 0 to 360 degrees about the base 10.

The base 10 is generally in the form of a hollow circular cylinder which defines an accommodating space 11. A circumferential wall of the base 10 defines a plurality of air inlets 12 in communication with the accommodating space 11.

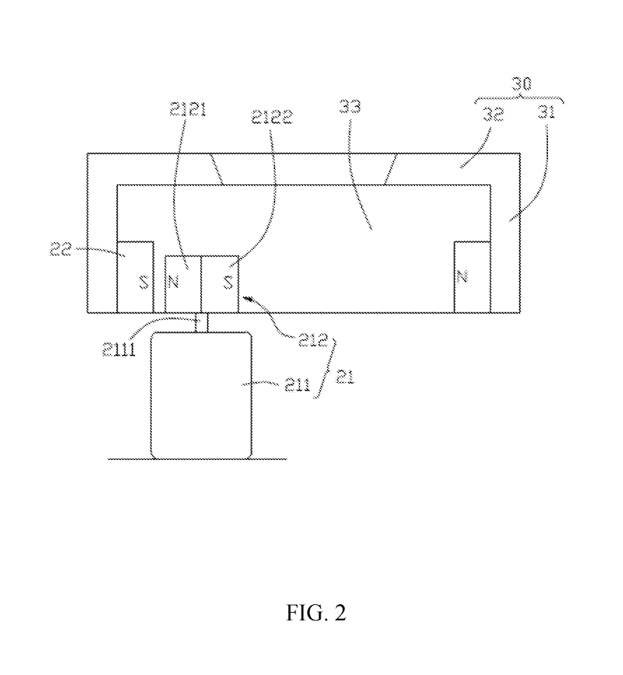

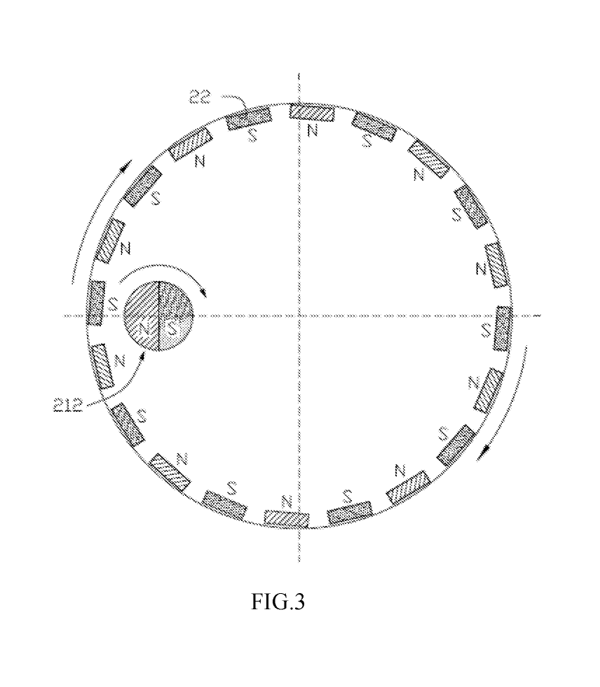

Referring also to FIG. 2 and FIG. 3, FIG. 2 and FIG. 3 illustrate positional relationship between the driving device 20 and rotary body 30, viewed from different aspects. The driving device 20 includes a motor assembly 21 and a plurality of first magnets 22. In this embodiment, the motor assembly 21 includes a motor 211 and a second magnet 212 connected to the motor 211. The motor 211 includes a rotary shaft 2111. The rotary shaft 2111 has one end extending out of the motor 211 and connected to the second magnet 212. The second magnet 212 is cylindrical, which includes a first semi-cylinder 2121 and a second semi-cylinder 2122. A circumferential surface of the first semi-cylinder 2121 and a circumferential surface of the second semi-cylinder 2122 have opposite polarities. In this embodiment, the circumferential surface of the first half-cylinder 2121 has N-polarity, while the circumferential surface of the second semi-cylinder 2122 has S-polarity.

The motor 211 is mounted within the base 10. In this embodiment, a tray 13 protrudes from the base 10 in an interior thereof. The motor 211 is mounted on the tray 13. The motor 211 may be a brushless direct current motor (single-phase or multi-phase), a step motor or a synchronous motor.

One end of the rotary body 30 is connected to the nozzle 40, and the other end is connected to the base 10. In this embodiment, the rotary body 30 is generally in the form of a hollow cylindrical structure, which includes an annular wall 31 and a connecting wall 32. The annular wall 31 and the connecting wall 32 cooperatively define an accommodating chamber 33. The multiple first magnets 22 are arranged circumferentially about the annular wall 31 and, in particular, are mounted to an inner side of the annular wall 31 at even intervals. In this embodiment, the first magnets 22 are also disposed at one end of the annular wall 31 adjacent the base 10. In this embodiment, each first magnet 22 is generally rectangular in shape and is polarized along a circumferential direction of the annular wall 31. As such, each first magnet 22 forms one magnetic pole, and the polarities of adjacent first magnets 22 are opposite to each other. Specifically, the multiple first magnets 22 are arranged along a circumferential direction of the annular wall 31, and surfaces of the first magnets 22 facing a center of the rotary body 30 have N-polarities and S-polarities alternatively arranged along the circumferential direction of the annular wall 31, such that a plurality of alternatively arranged N-polarities and S-polarities is formed along an inner circumferential surface of the annular wall 31.

In this embodiment, the second magnet 212 is accommodated in the accommodating chamber 33 and offset from a center of the annular wall 31, with the first magnets 22 disposed between the annular wall 31 and the second magnet 212, and an axis of the second magnet 212 parallel to an axis of the annular wall 31.

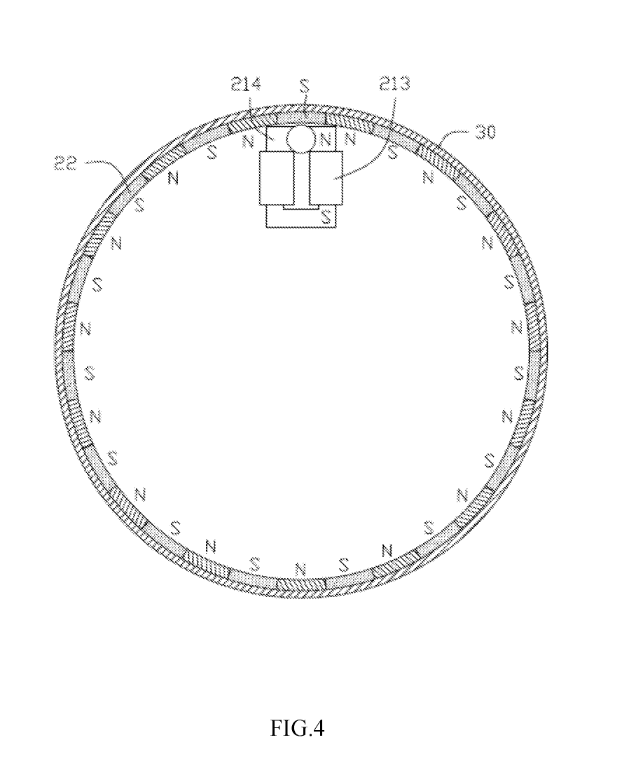

As the motor 211 operates to drive the rotary shaft 2111 to rotate, the rotary shaft 2111 in turn drives the second magnet 212 to rotate. Under the magnetic force of the first magnets 22 and the second magnet 212, the multiple first magnets 22 are driven to move, thereby driving the rotary body 30 and the nozzle 40 to rotate, such that the pressurized air is ejected through different angles. Referring also to FIG. 4, FIG. 4 illustrates the driving device 20 according to another embodiment. In this embodiment, the motor assembly 21 does not include the second magnet 212 and is a permanent magnet motor. Preferably, the permanent magnet motor is an outer-rotor unidirectional permanent magnet motor, which includes a stator 213 and a rotor having a plurality of permanent magnets 214. The stator 213 is disposed within the rotor. The multiple permanent magnets 214 rotate about the stator 213. The rotary body 30 is rotated by the magnetic force of the permanent magnets 214 and the first magnets 22. The motor assembly 21 of this embodiment eliminates the second magnet 212 which reduces the manufacturing cost. In addition, the rotary body 30 is driven to rotate by the magnetic force of the permanent magnets 214 of the motor 211 and the first magnets 22, thereby reducing an axial length of the driving device 20.

The nozzle 40 is generally annular, which includes an air passage 41 formed in an interior of the nozzle 40 along a circumferential direction of the nozzle 40. One end of the air passage 41 is in communication with outside air, and the other end is in communication with the pressurizer 50. The air passage 41 is used to deliver the airflow. It should be understood that, in other embodiments, the nozzle 40 may be rectangular, triangular, or polygonal in shape.

In this embodiment, the accommodating space 11 of the base 10 is greater than the accommodating chamber 33 of the rotary body 30 in volume.

The pressurizer 50 is mounted within the accommodating space 11 and includes a pressurizer motor 51 and a plurality of flow passages 52. The air inlets 12 are in communication with an inlet end (not shown) of the pressurizer 50, the flow passages 52, an outlet end (not shown) of the pressurizer 50, and the nozzle 40. The pressurizer motor 51 operates to suck air into the flow passages 52 via their respective air inlets 12. The sucked air is pressurized by the pressurizer motor 51, discharged to the air passage 41 via the flow passages 52, and ejected to the outside environment from the bladeless fan 100 via the air passage 41 of the nozzle 40.

The bladeless fan 100 further includes a conducting wire 60 for connecting with an external power supply (not shown). The conducting wire 60 is used to supply power to the motor 211 of the driving device 20 and the pressurizer motor 51 of the pressurizer 50, thereby avoiding tangle of the conducting wire 60 during operation of the bladeless fan 100. Specifically, the pressurizer motor 30 and the motor 211 of the driving device 20 are both mounted within the base 10, the conducting wire 60 passes through the base 10 to supply power to the pressurizer motor 30 and the motor 211 of the driving device 20. The base 10 does not rotate during operation of the bladeless fan 100, such that the conducting wire 60 is in static state and avoids a tangle issue.

In the bladeless fan 100 of the present invention, the rotary body 30 is rotated by the magnetic force of the first magnets 22 of the driving device 20 and the second magnet 212. This contactless magnetic driving manner results in lowered noise during rotation of the rotary body 30 relative to the base 10. In addition, in comparison with the conventional mechanical driving manner such as gear driving, the driving device 20 using the magnetic force has a simple structure and low cost and is convenient to fabricate. The bladeless fan 100 using the driving device 20 of the present invention has reduced weight and volume and prolonged lifespan in comparison with the conventional fans. In addition, because the contactless magnetic driving manner is used, no wear is generated during the driving course, which leads to a more even rotation speed. It should be understood that a rotation direction of the rotary body 30 can be adjusted by controlling a rotation direction of the motor 211.

It should be understood that a swing angle of the rotary body 30 can be set by controlling a rotation angle of the motor 211 using a timer.

It should be understood that a rotation speed of the rotary body 30 can be adjusted by controlling the motor 211 using, for example, PWM control signals.

It should be understood that the multiple first magnets 22 may be replaced by a magnetic ring magnetized to have a plurality of magnetic poles. The magnetic ring, after magnetized, has multiple N-polarities and S-polarities arranged alternatively along a circumferential direction of the magnetic ring.

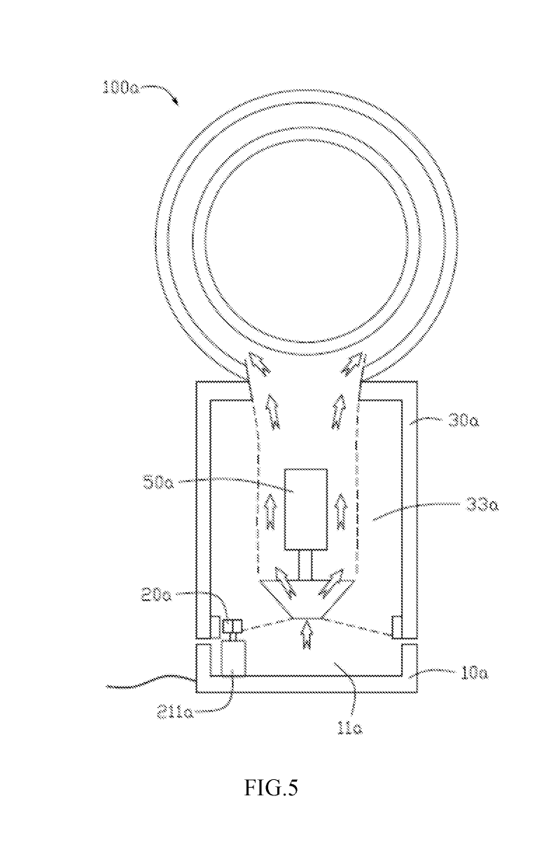

Referring to FIG. 5, FIG. 5 is a plan view of a bladeless fan 100a in accordance with a second embodiment of the present invention. This embodiment differs from the first embodiment in that, the accommodating space 11a of the base 10a is less than the accommodating chamber 33a of the rotary body 30a in volume, the pressurizer 50a is disposed within the accommodating chamber 33a of the rotary body 30a, and the motor 211a of the driving device 20a is mounted at a bottom of the base 10a.

The above embodiments are merely to illustrate the technical solutions of the present invention and are not intended to limit the present invention. Although the present invention has been described with reference to the above preferred embodiments, it should be appreciated by those skilled in the art that various modifications and variations may be made without departing from the spirit and scope of the present invention.

1. A driving device configured to drive a rotary body, the driving device comprising:
a motor assembly; and
a plurality of first magnets disposed on the rotary body along a circumferential direction thereof, sides of the plurality of first magnets facing the motor assembly forming a plurality of magnetic poles, and, upon rotation of the motor assembly, the plurality of first magnets being driven by magnetic force between the motor assembly and the plurality of magnets to rotate to drive the rotary body to rotate.

2. The driving device of claim 1, wherein the plurality of first magnets forms a magnetic ring magnetized to have multiple N-polarities and S-polarities arranged alternatively along a circumferential direction thereof.

3. The driving device of claim 1, wherein the plurality of first magnets is arranged along the circumferential direction of the rotary body, and surfaces of the plurality of first magnets away from the rotary body have N-polarities and S-polarities alternatively arranged along a circumferential direction of the rotary body.

4. The driving device of claim 1, wherein the rotary body comprises an annular wall, the plurality of first magnets is mounted on the annular wall, and sides of the plurality of first magnets away from the annular wall have N-polarities and S-polarities alternatively arranged along a circumferential direction of the annular wall.

5. The driving device of claim 1, wherein the motor assembly comprises a motor and a second magnet connected to the motor, the second magnet comprises a first semi-cylinder and a second semi-cylinder, a circumferential surface of the first semi-cylinder and a circumferential surface of the second semi-cylinder have opposite polarities, the second magnet is accommodated within the rotary body and offsets from a center of the rotary body, the plurality of first magnets is disposed between the rotary body and the second magnet, and an axis of the second magnet is parallel to an axis of the rotary body.

6. The driving device of claim 5, wherein the motor is a single-phase brushless direct current motor, a multi-phase brushless direct current motor, a step motor or a synchronous motor.

7. The driving device of claim 1, wherein the motor assembly is a permanent magnet motor which comprises a stator and a rotor having a plurality of permanent magnets, and the rotary body rotates under magnetic force of the plurality of permanent magnets and the plurality of first magnets.

8. The driving device of claim 7, wherein the permanent magnet motor is an outer-rotor unidirectional permanent magnet motor.

9. A bladeless fan comprising:
a base,
a rotary body having one end rotatably connected to the base;
a pressurizer;
a nozzle connected to one end of the rotary body away from the base; and
a driving device comprising:
a motor assembly mounted to the base; and
a plurality of first magnets disposed on a rotary body along a circumferential direction thereof, sides of the plurality of first magnets facing the motor assembly forming a plurality of magnetic poles, and, upon rotation of the motor assembly, the plurality of first magnets being driven by magnetic force between the motor assembly and the plurality of first magnets to rotate to drive the rotary body to rotate, the driving device being configured to drive the rotary body to rotate relative to the base, and the pressurizer being configured to suck and pressurize air such that the pressurized air is ejected out via the nozzle.

10. The bladeless fan of claim 9, wherein the base has an accommodating space, and the pressurizer is mounted within the accommodating space.

11. The bladeless fan of claim 9, wherein a tray protrudes from the base in an interior thereof, and the motor assembly is mounted on the tray.

12. The bladeless fan of claim 9, wherein the rotary body has an accommodating chamber, and the pressurizer is mounted within the accommodating chamber.

13. The bladeless fan of claim 12, wherein the motor assembly is mounted at a bottom of the base.

14. The bladeless fan of claim 9, wherein a circumferential wall of the base defines a plurality of air inlets.

15. The bladeless fan of claim 9, wherein the bladeless fan further comprises a conducting wire disposed at the base.
